(19) United States
(12) Patent Application Publication
(10) Pub. No.: US 2004/0229641 A1
(43) Pub. Date: Nov. 18, 2004

(54) Mobile communication system, wireless base station apparatus and power control method for use therein

(75) Inventor: Kenki Takagi, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/811,284

(22) Filed: Mar. 26, 2004

(30) Foreign Application Priority Data
Mar. 26, 2003 (JP) 84036/2003

(51) Int. Cl. H04Q 7/20; H04B 7/00

(52) U.S. Cl. 455/522; 455/450; 455/509

(57) ABSTRACT

A wireless base station apparatus capable of keeping the quality of reception of a forward link dedicated physical control channel at mobile station terminals at a constant level all the time is to be provided. An encoding unit processes data encoding of user data, while a rate matching unit processes rate matching of the encoded data. An offset power level correcting unit corrects the offset power level of control information on the user data. A dedicated physical data channel generating unit generates a dedicated physical data channel from data having gone through rate matching, while a dedicated physical control channel generating unit generates a dedicated physical control channel from control information whose offset power level has been corrected. A time-division multiplexing unit subjects those dedicated physical data channel and dedicated physical control channel to time-division multiplexing.

### BACKGROUND OF THE INVENTION

1. Field of the Invention

The present invention relates to a mobile communication system, a wireless base station apparatus and a power control method for use therein, and more particularly to a power control method for use in a mobile communication system of the code division multiple access (CDMA) formula.

2. Description of the Related Art

In a conventional mobile communication system of the CDMA formula, a dedicated physical data channel for transmitting data and a dedicated physical control channel, both of the forward link, are time-division multiplexed for transmission to mobile station terminals.

A dedicated physical data channel is a channel for transmitting user data to mobile station terminals, while a dedicated physical control channel is a channel for transmitting control information in a physical layer. The control information consists of a pilot bit of a known pattern for use in channel estimation in synchronous detection, a transmission power control (TPC) command and a transport format combination indicator (TFCI). Incidentally, the TFCI is an item of information indicating how many transport channels are multiplexed in the reception frame of a dedicated physical data channel of the forward link or which transport channel uses which transport format.

While the dedicated physical data channel of the forward link is encoded in an algorithm having such error correcting capabilities as a turbo code or a convolution code, the dedicated physical control channel is not encoded.

For this reason, in a wireless base station apparatus, it is necessary to take into account the encoding gain of the dedicated physical data channel and raise, out of the transmission power levels of the time-division multiplexed the dedicated physical data channel and the dedicated physical control channel, the transmission level of the dedicated physical control channel by as much as the encoding gain.

Especially where outer loop power control of the forward link is performed, it is judged whether or not the qualitative requirement is satisfied by the encoded dedicated physical data channel, and the target of the signal to interference ratio (SIR) of the forward link is lowered to achieve convergence at a level where a certain qualitative requirement is met.

A signal of the same SIR level may differ in reception quality in a different wireless propagation environment. The outer loop power control of the forward link means measuring the block error rate (BLER) of received signals in such a case and judging whether or not the qualitative requirement prescribed by the network and service is satisfied, i.e. a control to determine the target SIR level satisfying the requirement of the whole system. This control is disclosed in, for instance, W-CDMA Mobile Communication Formula: 2-2W-CDMA Basic Transmission Technology (in Japanese, edition supervised by Keiji Tachikawa, published by Maruzen Co., Ltd. on Jun. 25, 2001), p. 55.

Thus, when outer loop power control of the forward link is being performed, the transmission power from dedicated physical channels from the wireless base station apparatus is lowered, and converged at a level where the qualitative requirement of the user data unit can be met. As a consequence, the pilot, TPC command and TFCI of the dedicated physical control channel not encoded fail to satisfy the qualitative requirement as much as the encoding gain of the dedicated physical data channel.

In a currently available mobile communication system of the CDMA formula, in order to avoid this, it is possible to have a fixed value of the encoding gain of the dedicated physical data channel to supplement the transmission power of the dedicated physical control channel. This parameter can only be set when the transport channel is set, and can have only a fixed value, which can never be made variable at any time during communication.

However, in the conventional mobile communication system of the CDMA formula, by the difference between the dedicated physical data channel and the dedicated physical control channel not only the difference of the encoding gain (a turbo code or convolution code and the absence of encoding) but also bit repetition or bit thinning-out due to rate matching is affected.

Where bit repetition is frequent, the error correction rate correspondingly rises, resulting. in improved reception quality at mobile station terminals, which are thereby enabled to obtain high enough quality even with low reception power.

On the other hand, where bit thinning-out is frequent, the error correction rate at mobile station terminals is lower than at normal times, resulting in poorer reception quality than at normal times and accordingly higher reception power demanded of the wireless base station apparatus to meet the qualitative requirement.

### SUMMARY OF THE INVENTION

An object of the present invention is to obviate the problems noted above and provide a mobile communication system capable of enabling mobile station terminals to keep the reception quality of the forward link dedicated physical control channel at a constant level all the time, a wireless base station apparatus and a power control method for use therein.

Another object of the invention is to provide a mobile communication system capable of alleviating a drop in the overall accommodating capacity of mobile station terminals in the system, a wireless base station apparatus and a power control method for use therein.

A mobile communication system according to the invention, by which a dedicated physical data channel with error correction and a dedicated physical control channel without error correction, both of the forward link, are time-division multiplexed and transmitted from a wireless base station apparatus to mobile station terminals, is provided with:

means for correcting transmission power with the encoding gain of the dedicated physical data channel being taken into consideration, and means for transmitting the dedicated physical channels of the forward link with the corrected transmission power.

A wireless base station apparatus according to the invention, by which a dedicated physical data channel with error correction and a dedicated physical control channel without error correction, both of the forward link, are time-division multiplexed and transmitted to mobile station terminals, is provided with:

means for correcting transmission power with the encoding gain of the dedicated physical data channel being taken into consideration, and means for transmitting the dedicated physical channels of the forward link with the corrected transmission power.

A power control method according to the invention is intended for a mobile communication system by which a dedicated physical data channel with error correction and a dedicated physical control channel without error correction, both of the forward link, are time-division multiplexed and transmitted from a wireless base station apparatus to mobile station terminals, provided on the radio base station side with a step of correcting transmission power with the encoding gain of the dedicated physical data channel being taken into consideration, and a step of transmitting the dedicated physical channels of the forward link with the corrected transmission power.

Thus the mobile communication system according to the invention using the CDMA formula corrects the encoding gain (fixed) of transmission power obtained by error correction processing (encoding) on the dedicated physical data channel (with error correction) and the dedicated physical control channel (without error correction), both of the forward link, which are time-division multiplexed and transmitted, on the basis of bit thinning-out/repetition due to rate matching figured out from variations in transmitted data quantity, adds the power level of the corrected gain to the dedicated physical control channel, and transmits the result as forward link dedicated physical channels from the wireless base station apparatus.

In this way, the mobile communication system according to the invention can keep the balance in transmission power between the time-division multiplexed dedicated physical data channel and the dedicated physical control channel without raising the signal to interference ratio (SIR) of reception at the mobile station terminals to an unnecessarily high level, enabling the dedicated physical control channel to maintain all the time a constant level at which channel estimation is possible.

To describe it in more specific terms, in the mobile communication system of the CDMA formula, dedicated physical channels composed by time-division multiplexing a dedicated physical data channel and a dedicated physical control channel are used for communication between the wireless base station apparatus and mobile station terminals. In this communication, the initial transmission power level set on the dedicated physical data channel is used for setting a higher power level than that of the dedicated physical data channel with the encoding gain of the dedicated physical data channel being taken into consideration.

The transmission power of the dedicated physical control channel is set here at a level higher than that of the dedicated physical data channel by the encoding gain of the dedicated physical data channel for the following reason: when the forward link transmission power level is converged so that the dedicated physical data channel having undergone error correction processing under the forward link outer loop power control performed at mobile station terminals so as to satisfy the pertinent qualitative requirement, the dedicated physical control channel having undergone no error correction processing cannot keep the required qualitative standard. By setting the transmission power of the dedicated physical control channel at a level higher than that of the dedicated physical data channel by the encoding gain of the dedicated physical data channel, it is made possible for the mobile station terminals to be ensured a certain level of reception quality on both channels.

However, since the data quantity transmitted on the dedicated physical data channel varies at each of transmission time intervals, user data differing in quality of service (QoS) are mapped on the physical channels. (For instance, in a situation where voice communication and packet communication are present in mixture, the voice communication which permits no long delay and the pack communication of an e-mail or the like which permits some delay differ in QoS.) For this reason, bit repetition/bit thinning-out by rate matching to satisfy the QoS requirements at the same time varies (as different QoS requirements are satisfied at the same time by varying the data quantity ratio).

The consequence is that the data quantity on the dedicated physical data channel varies at each of transmission time intervals, resulting in fluctuations in the quality of reception. For this reason, where a power difference reflecting an encoding gain can be set only as a fixed value as in the conventional process, fluctuations in bit repetition/bit thinning-out might make it impossible for the quality of reception at mobile station terminals to be maintained at a certain constant level all the time.

In view of this problem, in the mobile communication system according to the invention, bit repetition/bit thinning-out due to rate matching at each of the transmission time intervals is taken into consideration, and the transmission power level to be added to the dedicated physical control channel is corrected. The corrected offset level is added to the power level of the encoding gain of the dedicated physical data channel, and transmission of the time-division multiplexed dedicated physical control channel of the forward link takes place as the transmission power level of the dedicated physical control channel.

In the mobile communication system according to the invention, with the bit repetition/bit thinning-out due to rate matching being taken into consideration at each of the transmission time intervals, the power level of the encoding gain of the dedicated physical data channel is corrected, and the corrected level is added to the dedicated physical control channel. It is thereby made possible to provide the mobile station terminals with reception quality of the forward link dedicated physical control channel at a constant level all the time, not varying from one to another of the transmission time intervals.

Since this also prevents the wireless base station apparatus from transmitting the dedicated physical control channel with unnecessarily high power, it is made possible to alleviate a drop in the overall accommodating capacity of the system due to an increase in the transmission power of the wireless base station apparatus. Incidentally, the reverse link represents transmission from the mobile station terminals to the wireless base station apparatus, and the forward link, from the wireless base station apparatus to the mobile station terminals.

As described above, the mobile communication system, wireless base station apparatus and power control method for use therein according to the present invention enables the quality of reception of the forward link dedicated physical control channel at the mobile station terminals at a constant level all the time.

Furthermore, the mobile communication system, wireless base station apparatus and power control method for use therein according to the invention enables a drop in the overall accommodating capacity of the mobile station terminals of the system to be alleviated.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram of the configuration of a mobile communication system, which is a preferred embodiment of the invention;

FIG. 2 shows a typical configuration of the wireless base station apparatus in FIG. 1;

FIG. 3 shows a form of transmission of forward link user data in the embodiment of the invention;

FIG. 4 illustrates bit thinning-out by rate matching of forward link user data in the embodiment of the invention;

FIG. 5 illustrates bit repetition by rate matching of forward link user data in the embodiment of the invention;

FIG. 6 illustrates correction of transmission power on a dedicated physical control channel in the embodiment of the invention;

FIG. 7 is a sequence chart showing the operation of the mobile communication system, which is the embodiment of the invention.

### DETAILED DESCRIPTION OF PREFERRED EMBODIMENT

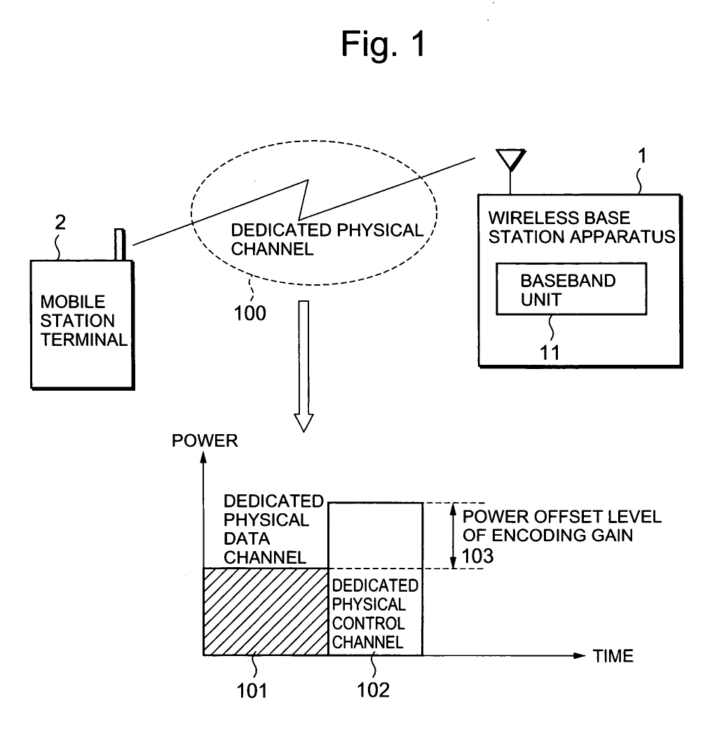

A preferred embodiment of the present invention will be described below in detail with reference to the drawings. FIG. 1 is a block diagram of the configuration of a mobile communication system, which is the preferred embodiment of the invention. Referring to FIG. 1, the mobile communication system embodying the invention uses the code division multiple access (CDMA) formula, and comprises a wireless base station apparatus 1 and a mobile station terminal 2. In the wireless base station apparatus 1 is provided a baseband unit 11, which processes rate matching and performs various measurements.

In a conventional mobile communication system of the CDMA formula, wireless base station apparatuses 1 are arranged at intervals of a few kilometers, each constituting an area, and wireless links are established between each wireless base station apparatus 1 and a plurality of mobile station terminals 2. In FIG. 1, it is supposed that a wireless link is established between the wireless base station apparatus 1 and the mobile station terminal 2.

A forward link dedicated physical channel 100 is formed by time-division multiplexing of a dedicated physical data channel 101 and a dedicated physical control channel 102. In this embodiment, optimization of the balance in transmission power between the time-division multiplexed dedicated physical data channel 101 and the dedicated physical control channel 102 is sought.

Usually, the dedicated physical data channel 101 is encoded with an error correcting code such as a turbo code or a convolution code, and has a high error correcting capability. On the other hand, the dedicated physical control channel 102 is not encoded and has no error correcting capability.

Therefore, when power is controlled to satisfy the qualitative requirement of the dedicated physical data channel 101 by the outer loop power control of the forward link, the qualitative requirement cannot be satisfied on the dedicated physical control channel 102, which has no error correcting capability, inviting a call cut-off in the worst case.

For this reason, it is possible for the present mobile communication system of the CDMA formula to keep fixed the transmission power difference between the dedicated physical data channel 101 and the dedicated physical control channel 102, i.e. the power level of the encoding gain of the dedicated physical data channel as an offset level 103.

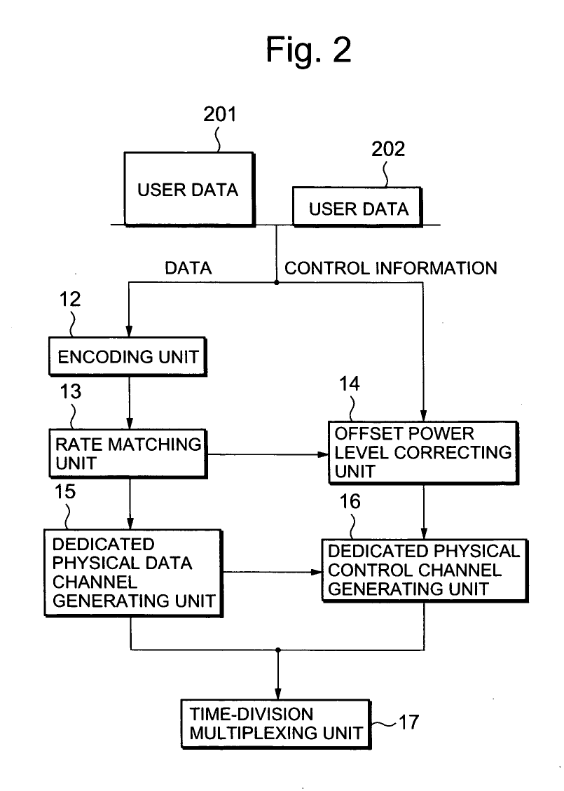

FIG. 2 shows a typical configuration of the wireless base station apparatus 1 in FIG. 1. In FIG. 2, the wireless base station apparatus 1 comprises an encoding unit 12, a rate matching unit 13, an offset power level correcting unit 14, a dedicated physical data channel generating unit 15, a dedicated physical control channel generating unit 16 and a time-division multiplexing unit 17. The encoding unit 12 processes data encoding of user data 201 and 202, while the rate matching unit 13 processes rate matching of the encoded data. The offset power level correcting unit 14 corrects the offset power level of control information on the user data 201 and 202.

The dedicated physical data channel generating unit 15 generates a dedicated physical data channel from data having gone through rate matching, while the dedicated physical control channel generating unit 16 generates a dedicated physical control channel from control information whose offset power level has been corrected. The time-division multiplexing unit 17 subjects those dedicated physical data channel and dedicated physical control channel to time-division multiplexing.

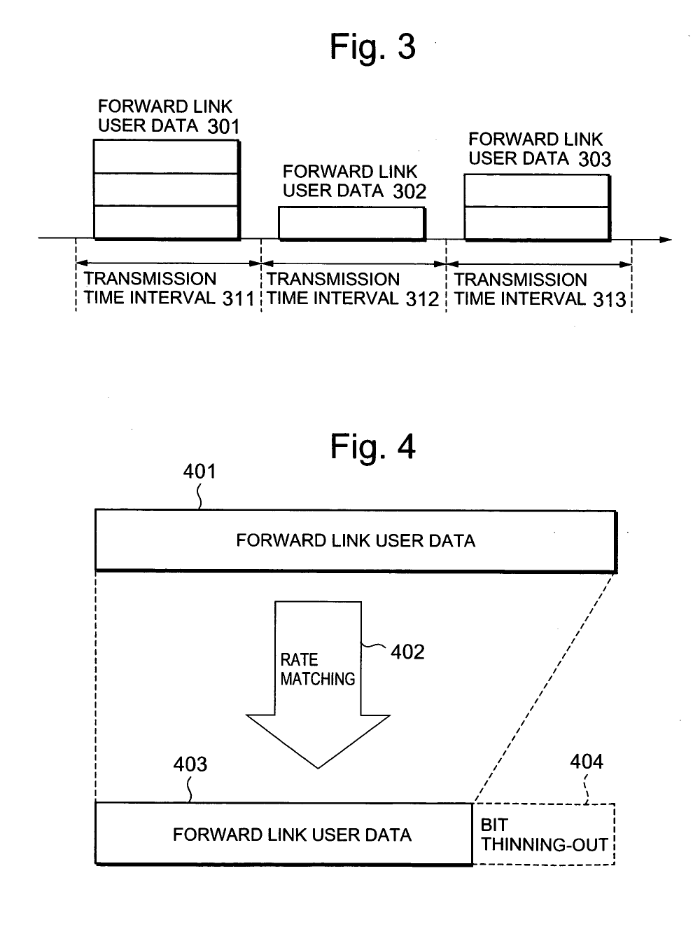

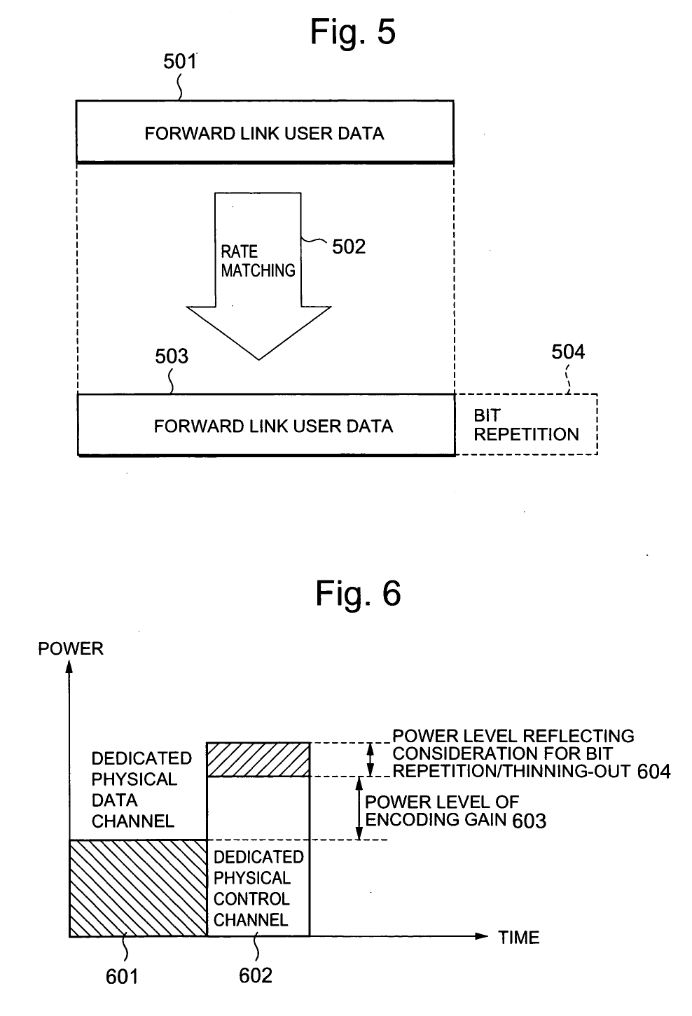

FIG. 3 shows a form of transmission of forward link user data in the embodiment of the invention shows a form of transmission of forward link user data in the embodiment of the invention. FIG. 4 illustrates bit thinning-out by rate matching of forward link user data in the embodiment of the invention. FIG. 5 illustrates bit repetition by rate matching of forward link user data in the embodiment of the invention. FIG. 6 illustrates correction of transmission power on a dedicated physical control channel in the embodiment of the invention.

Referring to FIG. 3, forward link user data 301 through 303 are mounted on a forward link dedicated physical data channel at every one of transmission time intervals 311 through 313. As s result, the forward link user data 301 through 303 differ in data quantity from one to another of the transmission time intervals 311 through 313.

For this reason, a bit thinning-out 404 due to rate matching 402 as shown in FIG. 4 or a bit repetition 504 due to rate matching 502 as shown in FIG. 5 may occur in the forward link user data 301 through 303 at each of the transmission time intervals 311 through 313.

In this embodiment, as shown in FIG. 6, the bit thinning-out 404 or the bit repetition 504 due to the rate matching of the data section of the user data received by the wireless base station apparatus 1 is figured out and, on the basis of the figured-out result, a power level (fixed) 603 set as the encoding gain of a dedicated physical data channel 601 is corrected. (The corrected level is a power level 604 reflecting consideration for bit thinning-out/repetition due to rate matching shown in FIG. 6). Then, the corrected power level is added to the transmission power of a dedicated physical control channel 602, and the dedicated physical data channel and the dedicated physical control channel are time-division multiplexed, and transmitted to a wireless section. These steps of processing are performed by the wireless base station apparatus 1 whose configuration is shown in FIG. 2.

As the dedicated physical data channel differs in transmitted data quantity from one to another of the transmission time intervals 311 through 313 as shown in FIG. 3, user data differing in quality of service (QoS) are mapped on the physical channel. (For instance, in a situation where voice communication and packet communication are present in mixture, the voice communication which permits no long delay and the pack communication of an e-mail or the like which permits some delay differ in QoS.) For this reason, the bit repetition/bit thinning-out by rate matching to satisfy the QoS requirements at the same time varies (as different QoS requirements are satisfied at the same time by varying the data quantity ratio).

Thus, the data quantity on the dedicated physical data channel of each mobile station terminal 2 varies from one to another of the transmission time intervals 311 through 313, and the reception quality fluctuates as a result. Where a power difference reflecting an encoding gain can be set only as a fixed value as in the conventional process, fluctuations in bit repetition/bit thinning-out might make it impossible for the quality of reception at mobile station terminals 2 to be maintained at a certain constant level all the time.

In view of this problem, in this embodiment of the invention, the bit repetition 504/bit thinning-out 404 (see FIG. 4 and FIG. 5) due to rate matching at each of the transmission time intervals 311 through 313 is taken into consideration as shown in FIG. 3, and the transmission power level (the encoding gain of the dedicated physical data channel 601) to be added to the dedicated physical control channel is corrected as shown in FIG. 6.

The corrected offset level (the power level 604 reflecting the bit thinning-out/repetition due to rate matching shown in FIG. 6) is added to the power level 603 of the encoding gain of the dedicated physical data channel 601, and transmission of the time-division multiplexed dedicated physical control channel of the forward link takes place as the transmission power level of the dedicated physical control channel 602.

In this embodiment, the bit repetition 504/bit thinning-out 404 due to rate matching being taken into consideration at each of the transmission time intervals 311 through 313, the power level 603 of the encoding gain of the dedicated physical data channel 601 is corrected, and the corrected level is added to the dedicated physical control channel 602. It is thereby made possible to provide the mobile station terminals 2 with reception quality of the forward link dedicated physical control channel at a constant level all the time, not varying from one to another of the transmission time intervals 311 through 313.

Since this also prevents the wireless base station apparatus 1 from transmitting the dedicated physical control channel with unnecessarily high power, it is made possible to alleviate a drop in the overall accommodating capacity of the system due to an increase in the transmission power of the wireless base station apparatus 1. Incidentally, the reverse link represents transmission from the mobile station terminals 2 to the wireless base station apparatus 1, and the forward link, from the wireless base station apparatus 1 to the mobile station terminals 2.

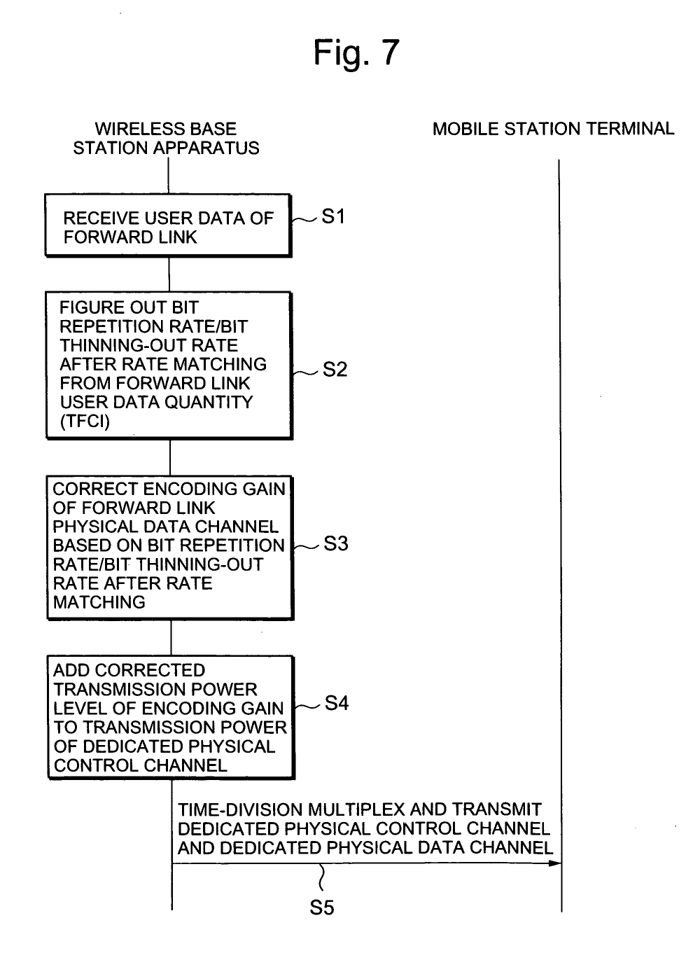

FIG. 7 is a sequence chart showing the operation of the mobile communication system, which is the embodiment of the invention. The operation of the mobile communication system, which embodies the invention, will be described with reference to these FIG. 1 through FIG. 7.

First, the wireless base station apparatus 1 receives the user data 201 and 202 from a host apparatus (not shown) (step S1 in FIG. 7). In the wireless base station apparatus 1, in order to transmit user data differing in QoS over a single channel, variations in the number of bits (the bit repetition 504/bit thinning-out 404) in an encoded sequence (user data) mapped on the physical channel at each of the transmission time intervals 311 through 313 are figured out (rate matching) (step S2 in FIG. 7).

In the wireless base station apparatus 1, since the quality of reception at the mobile station terminals 2 differs depending on the bit repetition 504/bit thinning-out 404 due to rate matching obtained by the processing described above, a fixed value set as the transmission power level 603 of the encoding gain of the forward link dedicated physical data channel is corrected (step S3 in FIG. 7).

The wireless base station apparatus 1 adds the corrected transmission power level to the transmission power of the dedicated physical control channel, and transmits the dedicated physical data channel and the dedicated physical control channel in a time-division multiplexed form (steps S4 and S5 of FIG. 7).

Thus in this embodiment of the invention, the quality of reception at the mobile station terminals 2 is varied by the bit repetition 504/bit thinning-out 404 figured out at each of the transmission time intervals 311 through 313 by the rate matching. For this reason, the transmission power difference of the encoding gain between the dedicated physical data channel having undergone error correction and the dedicated physical control channel having undergone no error correction is corrected at each of the transmission time intervals 311 through 313 on the basis of the values figured out of this reception quality. This enables the embodiment to keep the quality of reception of the forward link dedicated physical control channel at the mobile station terminals 2 at a constant level all the time.

Further in this embodiment, the reduction in transmission by the wireless base station apparatus 1 at an unnecessarily high power level serves to reduce the level of interference to which the mobile station terminals 2 are subject, the mobile station terminals 2 are prevented from making a further power demand of the wireless base station apparatus 1, and a drop in the overall accommodating capacity of the mobile station terminals 2 of the system can be alleviated.

As hitherto described, the mobile communication system according to the present invention, by having the configuration and operating as stated above, provides the benefit of enabling the quality of reception of the forward link dedicated physical control channel at the mobile station terminals at a constant level all the time.

Furthermore, another mobile communication system according to the invention, by having the configuration and operating as stated above, provides the benefit of enabling a drop in the overall accommodating capacity of the mobile station terminals of the system to be alleviated.

While this invention has been described with reference to a certain preferred embodiment thereof, it is to be understood that the subject matter encompassed by this invention is not to be limited to this specific embodiment. Instead, it is intended for the subject matter of the invention to include all such alteratives, modifications and equivalents as can be encompassed by the spirit and scope of the following claims.

What is claimed is:

1. A mobile communication system by which a dedicated physical data channel with error correction and a dedicated physical control channel without error correction, both of the forward link, are time-division multiplexed and transmitted from a wireless base station apparatus to mobile station terminals, comprising:
a power correcting unit which corrects transmission power with the encoding gain of said dedicated physical data channel being taken into consideration, and
a transmitting unit which transmits said dedicated physical channels of the forward link with the corrected transmission power.

2. The mobile communication system, as claimed in claim 1, wherein:
said power correcting unit corrects said transmission power at each of transmission time intervals.

3. The mobile communication system, as claimed in claim 1, wherein:
said power correcting unit corrects the encoding gain of the transmission power obtained by error correction processing on said dedicated physical data channel and said dedicated. physical control channel on the basis of bit repetition/bit thinning-out due to rate matching figured out from variations in transmitted data quantity.

4. The mobile communication system, as claimed in claim 2, wherein:
said power correcting unit corrects the encoding gain of the transmission power obtained by error correction processing on said dedicated physical data channel and said dedicated physical control channel on the basis of bit repetition/bit thinning-out due to rate matching figured out from variations in transmitted data quantity.

5. The mobile communication system, as claimed in claim 3, wherein:
said rate matching is to satisfy quality of service (QoS) requirements for voice communication and packet communication at the same time.

6. The mobile communication system, as claimed in claim 4, wherein:
said rate matching is to satisfy QoS requirements for voice communication and packet communication at the same time.

7. The mobile communication system, as claimed in claim 1, wherein:
said mobile communication system utilizes the code division multiple access (CDMA) formula.

8. The mobile communication system, as claimed in claim 2, wherein:
said mobile communication system utilizes the CDMA formula.

9. The mobile communication system, as claimed in claim 3, wherein:
said mobile communication system utilizes the CDMA formula.

10. The mobile communication system, as claimed in claim 4, wherein:
said mobile communication system utilizes the CDMA formula.

11. The mobile communication system, as claimed in claim 5, wherein:
said mobile communication system utilizes the CDMA formula.

12. The mobile communication system; as claimed in claim 6, wherein:
said mobile communication system utilizes the CDMA formula.

13. A wireless base station apparatus by which a dedicated physical data channel with error correction and a dedicated physical control channel without error correction, both of the forward link, are time-division multiplexed and transmitted to mobile station terminals, comprising:
a power correcting unit which corrects transmission power with the encoding gain of said dedicated physical data channel being taken into consideration, and
a transmitting unit which transmits said dedicated physical channels of the forward link with the corrected transmission power.

14. The wireless base station apparatus, as claimed in claim 13, wherein:
said power correcting unit corrects said transmission power at each of transmission time intervals.

15. The wireless base station apparatus, as claimed in claim 13, wherein:
said power correcting unit corrects the encoding gain of the transmission power obtained by error correction processing on said dedicated physical data channel and said dedicated physical control channel on the basis of bit repetition/bit thinning-out due to rate matching figured out from variations in transmitted data quantity.

16. The wireless base station apparatus, as claimed in claim 14, wherein:
said power correcting unit corrects the encoding gain of the transmission power obtained by error correction processing on said dedicated physical data channel and said dedicated physical control channel on the basis of bit repetition/bit thinning-out due to rate matching figured out from variations in transmitted data quantity.

17. The wireless base station apparatus, as claimed in claim 15, wherein:
said rate matching is to satisfy QoS requirements for voice communication and packet communication at the same time.

18. The wireless base station apparatus, as claimed in claim 16 wherein:
said rate matching is to satisfy QoS requirements for voice communication and packet communication at the same time.

19. The wireless base station apparatus, as claimed in claim 13 wherein:
said mobile communication system utilizes the CDMA formula.

20. The wireless base station apparatus, as claimed in claim 14 wherein:
said mobile communication system utilizes the CDMA formula.

21. The wireless base station apparatus, as claimed in claim 15, wherein:
said mobile communication system utilizes the CDMA formula.

22. The wireless base station apparatus, as claimed in claim 16 wherein:
said mobile communication system utilizes the CDMA formula.

23. The wireless base station apparatus, as claimed in claim 17 wherein:
said mobile communication system utilizes the CDMA formula.

24. The wireless base station apparatus, as claimed in claim 18 wherein:
said mobile communication system utilizes the CDMA formula.

25. A power control method for a mobile communication system by which a dedicated physical data channel with error correction and a dedicated physical control channel without error correction, both of the forward link, are time-division multiplexed and transmitted from a wireless base station apparatus to mobile station terminals, comprising steps of:
correcting transmission power with the encoding gain of said dedicated physical data channel being taken into consideration, and
transmitting said dedicated physical channels of the forward link with the corrected transmission power.

26. The power control method, as claimed in claim 25 wherein:
said transmission power is corrected at each of transmission time intervals by said step of correcting transmission power.

27. The power control method, as claimed in claim 25 wherein:
the encoding gain of the transmission power obtained by error correction processing on said dedicated physical data channel and said dedicated physical control channel is corrected by said step of correcting transmission power on the basis of bit repetition/bit thinning-out due to rate matching figured out from variations in transmitted data quantity.

28. The power control method, as claimed in claim 26 wherein:
the encoding gain of the transmission power obtained by error correction processing on said dedicated physical data channel and said dedicated physical control channel is corrected by said step of correcting transmission power on the basis of bit repetition/bit thinning-out due to rate matching figured out from variations in transmitted data quantity.

29. The power control method, as claimed in claim 27 wherein:
said rate matching is to satisfy QoS requirements for voice communication and packet communication at the same time.

30. The power control method, as claimed in claim 28 wherein:
said rate matching is to satisfy QoS requirements for voice communication and packet communication at the same time.

31. The power control method, as claimed in claim 25 wherein:
said mobile communication system utilizes the CDMA formula.

32. The power control method, as claimed in claim 26 wherein:
said mobile communication system utilizes the CDMA formula.

33. The power control method, as claimed in claim 27 wherein:
said mobile communication system utilizes the CDMA formula.

34. The power control method, as claimed in claim 28 wherein:
said mobile communication system utilizes the CDMA formula.

35. The power control method, as claimed in claim 29 wherein:
said mobile communication system utilizes the CDMA formula.

36. The power control method, as claimed in claim 30 wherein:
said mobile communication system utilizes the CDMA formula.
